(19) United States
(12) Patent Application Publication
(10) Pub. No.: US 2008/0083411 A1
(43) Pub. Date: Apr. 10, 2008

(54) Self-Sterilizing Particulate Respirator Facepiece and Method for Using Same

(76) Inventor: STEVEN LYON GUTH, WATERFORD, MI (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 11/539,531

(22) Filed: Oct. 6, 2006

(51) Int. Cl. A62B 23/02

(52) U.S. Cl. 128/206.12; 95/285

(57) ABSTRACT

A particulate respirator facepiece has photocatalyst in the airflow path and a light source that illuminates the photocatalyst. Photocatalyst may include titanium oxide, tin oxide and other semiconductor photocatalysts. Strong oxidizers generated by the illuminated photocatalyst kill infectious agents and decompose toxic organic compounds. The particulate respirator facepiece can be used outdoors, illuminated by natural sunlight; indoors, illuminated by ambient lighting, and; in the dark, with the built-in light source. Light emitting diodes (LEDs) or another source of light built in to the particulate respirator facepiece illuminates the photocatalyst. Light conductors may be incorporated to distribute light from the built-in light source over the photocatalyst.

### FIELD OF THE INVENTION

The present invention relates generally to particulate respirator facepieces, and more particularly to a particulate respirator facepiece including such features as a photocatalyst in the airflow path, a source of light disposed to illuminate the photocatalyst and a power supply for the light source.

### BACKGROUND ART

For many years, people needing protection from inhaled airborne particulates have been able to reduce their exposure by wearing a particulate respirator facepiece over the mouth and nose. A typical particulate respirator facepiece can be worn without significantly encumbering the user.

In particulate respirators (also known as “air-purifying respirators”) air flows through a porous substrate, or filter. The filter blocks aerosols, solid particles or liquid droplets dispersed in the air. Aerosols collect on the filter, purifying the air that passes through and is inhaled. Particulate respirators, however, protect only against aerosols—not gases or vapors, which can pass through a porous substrate. Since infective airborne pathogens such as bacteria or viruses are solid particles, they can be filtered out of the airflow by particulate respirators.

The category of particulate facepiece respirators can be further divided into:
1. disposable or filtering facepiece respirators, where the entire respirator is discarded when it becomes unsuitable for further use due to excessive resistance to the flow of breath, sorbent exhaustion, contamination or physical damage (See, e.g., U.S. Pat. No. 4,536,440, which issued on Aug. 20, 1985, and U.S. Pat. No. 4,807,619, which issued on Feb. 28, 1989, the entireties of which are incorporated herein by reference);
2. reusable or elastomeric respirators, where the facepiece is cleaned and reused but filter modules or cartridges are discarded and replaced when they become unsuitable for further use (See, e.g., U.S. Pat. No. 6,345,620, which issued on Feb. 12, 2002, the entirety of which is incorporated herein by reference); and
3. powered air purifying respirators (PAPRs), where a battery-powered blower moves the air flow through the filters.

A particulate respirator facepiece can be relied upon to protect the wearer only when used correctly. If the respirator is not used correctly, it is very likely that it will not provide the protection expected, which may result in harm to the wearer. The key elements for respiratory protection are appropriate selection, fit-testing and training in the storage, maintenance, use, and disposal of the respirator. Conventionally, when a particulate respirator has been exposed to actual or suspected infectious agents, it is assumed to be contaminated. Once assumed contaminated, a particulate respirator is considered a potential source of further infection and must be carefully handled and properly discarded. In other words, conventional particulate respirator facepieces are disposed of as a precaution whenever exposure is presumed, regardless as to whether the particulate respirator facepieces are actually contaminated.

Others have recognized the problems associated with contamination of air filters and disposable particulate respirators. One proposed solution is the application of “microbicidal” compounds to the filter substrate (See, e.g., U.S. Patent Application Publication 2003/0205137, which published on Nov. 6, 2003, the entirety of which is incorporated herein by reference). The drawbacks of this approach include:

1. the narrow specificity of many antibiotic compounds,

2. development of drug resistance to antibiotic compounds,

3. allergic and toxic reactions to antibiotic compounds,

4. expense of antibiotic compounds, and

5. environmental release of antibiotic compounds.

### (Note that the term antibiotic is used here to refer to antimicrobial, antibacterial, antifungal, and antiviral compounds together as a group.)

Thus, the need exists for improved particulate respirators that have the ability to combat particulate respirator facepiece contamination. The need specifically exists for a particulate respirator having the ability to combat particulate respirator facepiece contamination, without one or more of the above-described deficiencies associated with particulate respirators that employ microbicidal compounds. The need also exists for a self-sterilizing particulate respirator. The need also exists for improving the usable lifetime of particulate respirator facepieces.

### SUMMARY OF THE INVENTION

The various embodiments of the present invention overcome some of the drawbacks of the prior art by inducing photo-oxidation of infectious agents and organic compounds that become trapped in a particulate respirator facepiece. In the presence of light and moisture, photocatalysts, such as titanium dioxide, generate highly reactive oxidizers, including hydroxyl radicals, which will quickly mineralize organic compounds and destroy infectious agents, e.g., microbes, bacteria, mold, spores, yeast, viruses, prions, etc. There is no known mechanism of resistance against photo-chemical oxidation.

Specifically, in one embodiment, the present invention relates to a particulate respirator facepiece that overcomes the aforementioned drawbacks regarding immediate and proper disposal upon presumed contamination of said particulate respirator facepiece.

The present invention has been developed in order to make particulate respirators self-sterilizing and self-decontaminating when exposed to hazardous aerosols, in general, and infectious aerosols, in particular. A self-sterilizing particulate respirator is worn as protection against air borne infection to trap pathogens on a filter and kill them, thereby mitigating the risk of infection posed by exposure to a contaminated respirator. Desirably, the self-sterilizing respirators can be handled, worn, re-used and disposed of with little concern for spreading infection or self-infection by the user. It is therefore an object of the present invention to provide a particulate respirator which is treated with a photocatalyst such as titanium dioxide nano-particles, or the like, which, in the presence of water vapor from exhaled breath, will generate highly reactive hydroxyl radicals that efficiently destroy infectious agents including viruses, bacteria, yeasts and molds.

According to one aspect of the invention, a particulate respirator facepiece includes semiconductor photocatalyst in the airflow path of the filter that is activated by exposure to light. In one embodiment, the photocatalyst comprises nano-particles of titanium oxide sensitive to light in the blue frequency range.

According to another aspect of the present invention, an illuminator may be mounted to the facepiece that directs light onto the air filter portion of the facepiece. Preferable, the illuminator comprises one or a plurality of light emitting diodes (LEDs). In one embodiment, six LEDs are mounted over the air filter portion of the facepiece. In another embodiment, six LEDs are mounted on the air filter portion of the facepiece. In this embodiment, a reflective coating on the lenses of the LEDs reflects light back onto the facepiece. Batteries may be used to supply electrical power to operate the illuminator. In one embodiment, a small battery housing is mounted on the elastic strap that secures the particulate respirator facepiece around the head of the user.

According to another aspect of the present invention, light is distributed from an illuminator by optical fibers, light pipes, ribbons or sheets over and within the filter substrate. Thus, in one aspect, the photocatalyst is irradiated with light emitted from a light conductor selected from the group consisting of fibers, pipes, ribbons and sheets.

In one embodiment, one, two or more LEDs illuminate the ends of a plurality of fiber optic ribbons (e.g., 2, 4, 6, 8, or 10 fiber optic ribbons) distributing light over the inner and outer surfaces of a particulate respirator facepiece.

In one embodiment, the particulate respirator facepiece has an elastomeric or reusable facepiece with replaceable air filter modules designed with LED illuminators disposed to illuminate said air filter modules.

In another embodiment the invention is to a filter having a fluid flow pathway and a photocatalyst disposed along at least a portion of the fluid flow pathway, wherein the photocatalyst is irradiated with light emitted from a light conductor selected from the group consisting of fibers, pipes, ribbons and sheets.

In another embodiment, the invention is to a method for effectively destroying a contaminant on a particulate respirator, comprising: (a) providing a particulate respirator comprising a facepiece having an air flow pathway and a photocatalyst disposed along at least a portion of the air flow pathway, wherein the air flow pathway comprises the contaminant; and (b) irradiating the photocatalyst with electromagnetic radiation, preferably UV radiation, under conditions effective to destroy the contaminant. Optionally, the destroying of the contaminants comprises photo-oxidizing the contaminant. In a preferred aspect, the particulate respirator further comprises a light source disposed to irradiate the photocatalyst. Optionally, the photocatalyst is irradiated by light emitted by a light conductor, which may be selected from the group consisting of fibers, pipes, ribbons and sheets.

### BRIEF DESCRIPTION OF THE DRAWINGS

The novel features and advantages of the present invention will be better understood by reference to the detailed description of the drawings which follows, when read in conjunction with the accompanying drawings, in which:

FIG. 1 depicts an exemplary embodiment of a disposable particulate respirator facepiece in accordance with one embodiment of the present invention;

FIG. 2 is a front view of an exemplary embodiment of a disposable particulate respirator facepiece in accordance with one embodiment of the present invention;

FIG. 3 is a side view of the disposable particulate respirator facepiece depicted in FIG. 2;

FIG. 4 is a top view of the disposable particulate respirator facepiece depicted in FIG. 2;

FIG. 5 depicts an exemplary embodiment of a reusable particulate respirator facepiece comprising a replaceable air filter module and a reusable headband illuminator in accordance with another embodiment of the present invention;

FIG. 6A is a front view of the reusable particulate respirator facepiece depicted in FIG. 5;

FIG. 6B is a front view of an exemplary embodiment of a reusable particulate respirator facepiece in accordance with the embodiment depicted in FIG. 5 showing the replaceable air filter module detached from the reusable headband illuminator;

FIG. 6C is a front view of the reusable particulate respirator facepiece depicted in FIG. 5 showing the reusable headband illuminator detached from the replaceable air filter module;

FIG. 7A is a side view of the reusable particulate respirator facepiece depicted in FIG. 5;

FIG. 7B is a side view of the reusable particulate respirator facepiece depicted in FIG. 5 showing the replaceable air filter module detached from the reusable headband illuminator;

FIG. 7C is a side view of the reusable particulate respirator facepiece depicted in FIG. 5 showing the reusable headband illuminator detached from the replaceable air filter module; and

FIG. 8A is a front view of a reusable particulate respirator facepiece comprising a reusable light conducting fibers module and a replaceable air filter module according to another embodiment of the present invention;

FIG. 8B is a front view of the reusable particulate respirator facepiece depicted in FIG. 8A showing the reusable light conducting fibers module detached from the replaceable air filter module;

FIG. 8C is a front view of the of the reusable particulate respirator facepiece depicted in FIG. 8A showing the replaceable air filter module without the reusable light conducting fibers module;

FIG. 9A is a side view of the reusable particulate respirator facepiece depicted in FIG. 8A;

FIG. 9B is a side view of the reusable particulate respirator facepiece depicted in FIG. 8A showing the reusable light conducting fibers module detached from the replaceable air filter module; and

FIG. 9C is a side view of the of the reusable particulate respirator facepiece depicted in FIG. 8A showing the replaceable air filter module without the reusable light conducting fibers module.

### DETAILED DESCRIPTION OF THE INVENTION

The present invention is directed to a particulate respirator comprising a facepiece having an air flow pathway and a photocatalyst disposed along at least a portion of the air flow pathway. In a preferred embodiment, the particulate respirator further comprises a light source for illuminating the photocatalyst contained in the facepiece in order to initiate photo-oxidation. Thus, the particulate respirator can be used outdoors, illuminated by natural sunlight; indoors, illuminated by ambient lighting; or in the dark, with the built-in light source.

In another embodiment, the invention is to a method for effectively destroying a contaminant on a particulate respirator, comprising: (a) providing a particulate respirator comprising a facepiece having an air flow pathway and a photocatalyst disposed along at least a portion of the air flow pathway, wherein the air flow pathway comprises the contaminant; and (b) irradiating the photocatalyst with electromagnetic radiation, preferably UV radiation, under conditions effective to destroy the contaminant. As used herein, the term “contaminant” means any composition that may become associated with a facepiece as a result of normal facepiece operation, and which may be harmful to its wearer. Non-limiting examples of contaminants include infectious compositions such as microbes, bacteria, mold, spores, yeast, viruses, and prions, as well as harmful organic compounds. As used herein, the term “destroy” means to convert the contaminant to a less harmful form. Optionally, the destroying of the contaminants comprises photo-oxidizing the contaminant. In a preferred aspect, the particulate respirator further comprises a light source disposed to irradiate the photocatalyst. Optionally, the photocatalyst is irradiated by light emitted by a light conductor, which may be selected from the group consisting of fibers, pipes, ribbons and sheets.

Photocatalysis is an oxidative chemical reaction that occurs when a semiconductor material is bombarded with high energy radiation sufficient to overcome the energy band gap of the semiconductor material. Photons of sufficient energy will promote electron and hole mobility within the valence and conductance bands of the semiconductor material, resulting in oxidation-reduction (redox) reactions with molecules on the surface of the semiconductor material. The electron and hole generated will recombine with each other almost instantly, therefore, only molecules adsorbed on the surface of the semiconductor material prior to generation of the electron and the hole can be involved in photo-catalytic redox reactions. If the unpaired electron is captured by a molecule on the surface of the semiconductor, a free radical is generated. Free radicals are chemical species that possess an unpaired electron in the outer (valence) shell of the molecule. The instability of the unpaired electron makes the free radical react quickly to capture an electron from the nearest stable molecule. That molecule has now lost its electron, and has an unpaired electron in the valence shell, generating a new free radical, thus propagating a chain reaction generating free radicals.

In an aqueous environment, photocatalysis of water will produce an abundance of hydroxyl radical (—OH), superoxide anion (O₂⁻) and hydrogen peroxide (H₂O₂). These highly reactive species have low chemical specificity, and will oxidize almost any molecule in their vicinity. Even complex organic molecules will be disrupted rapidly and completely. In the presence of UV light, proteins, lipids, polysaccharides, RNA and DNA, adsorbed to titanium dioxide (and other photocatalysts) will be mineralized to carbon dioxide, water, and inorganic acids. Therefore, photocatalysis can disrupt cell walls and destroy genetic material, quickly killing infectious agents.

Many semiconductor materials are effective photocatalysts, including, for example, BaTiO₃, Bi₂O₃, CdS, CeO₂, Cu₂O, Fe₂O3, GaP, GaAs, InP, InPb, KNbO₃, NiO, MoS₂, RuO₂, SiO, SiO₂, SnO₂, SrTiO₃, Ta₂O₅, TiO₂, WO₃, ZnO₂, and ZnO. Thus, the photocatalyst employed in the particulate respirator (e.g., in the particulate respirator facepiece) of the present invention optionally comprises a compound selected from the group consisting of BaTiO₃, Bi₂O₃, CdS, CeO₂, Cu₂O, Fe₂O₃, GaP, GaAs, InP, InPb, KNbO₃, NiO, MoS₂, RuO₂, SiO, SiO₂, SnO₂, SrTiO₃, Ta₂O₅, TiO₂, WO₃, ZnO₂, and ZnO. Semiconductor materials may be used as photocatalysts alone or in combinations. The anatase form of titanium dioxide (TiO₂) is a very efficient photocatalyst, and is commonly preferred for most photo-catalytic applications because it is abundant, inexpensive, stable, corrosion resistant, and non-toxic. Titanium dioxide is one of the least toxic substances known.

Desirably, hydroxyl radicals and other reactive molecules break down a wide variety of organic contaminants found in industrial gases, exhaust gases, room air, vapors, aqueous solutions and waste water. For additional description of the process and benefits of photo-oxidation, see, e.g., U.S. Pat. No. 5,480,524, which issued on Jan. 2, 1996; U.S. Pat. No. 5,689,798, which issued on Nov. 18, 1997; U.S. Pat. No. 5,736,055, which issued on Apr. 7, 1998; U.S. Pat. No. 5,779,912, which issued on Jul. 14, 1998; U.S. Pat. No. 5,790,934, which issued on Aug. 4, 1998; U.S. Pat. No. 5,919,422, which issued on Jul. 6, 1999. The entireties of each of these patents is incorporated by reference herein.

Research has shown that the efficiency of photocatalysis is limited by several factors. Electrons and holes re-couple and disappear prior to the oxidation-reduction of external substances. Lattice defects in the surface and interior portions of particles capture electrons and holes excited in semiconductor materials by UV light and cause them to re-couple before they reach the surface. A proportion of electrons and holes that reach the surface will re-couple before they can oxidize substances adsorbed to the surface. In order to ameliorate such problems, it is desirable to develop techniques for providing titanium dioxide that is free of lattice defects, and techniques for increasing separation between electrons and holes at the surface. Recently, several methods for improving the photo-catalytic properties of titanium oxide particles, have been disclosed:
1. Reduction in the size of photocatalyst particles will increase surface area, reduce recombination of photon-generated electrons and holes, and increase efficiency of photocatalysis. Unlike larger particles, which tend to flocculate in aqueous solution, nano-size particles (diameter less than 500 nm) remain dispersed indefinitely and the aqueous solution can be highly transparent.
2. Improvement in crystal structure will increase the rate of migration of photon-generated electrons and holes toward the surfaces of particles, reduce recombination and increase efficiency of photocatalysis (See, e.g., U.S. Pat. No. 6,828,273, which issued on Dec. 7, 2004; and U.S. Patent Application Publication 2005/0265917, which published on Dec. 1, 2005, the entireties of which are incorporated by reference herein.).
3. The energy band gap of the semiconductor material can be narrowed by introduction of small amounts of impurities. This allows photons of lower energy to stimulate photocatalysis (See, e.g., U.S. Pat. No. 6,828,273, which issued on Dec. 7, 2004, the entirety of which is incorporated by reference herein.).
4. Greater separation of holes and electrons achieved by an electrode formed on the surface of titanium dioxide which collects excited electrons. In photocatalysts of this type, referred to as metal-supporting photocatalysts, holes are separated and collected on the surface of the titanium dioxide, while electrons are separated and collected on the surface of the metal electrode, reducing the probability of re-coupling (See, e.g., U.S. Pat. No. 6,121,191, which issued on Sep. 19, 2000; and U.S. Pat. No. 6,828,273, which issued on Dec. 7, 2004, the entireties of which are incorporated by reference herein.).

Such improved photocatalysts have been applied generally to industrial processes, including desulphurization, decontamination of air and water. See, e.g., U.S. Patent Application Publication 2004/0170526, which published on Sep. 2, 2004; U.S. Patent Application Publication 2004/0224145, which published on Nov. 11, 2004; U.S. Patent Application Publication 2005/0217421, which published on Oct. 6, 2005, the entireties of which are incorporated by reference herein. Such photocatalysts have also been employed in air purification. See, e.g., U.S. Patent Application Publication 2005/0126428, which published on Jun. 16, 2005; and U.S. Patent Application Publication 2004/0163941, which published on Aug. 26, 2004, the entireties of which are incorporated by reference herein.

Photocatalysts have recognized and established value in the purification of air and water contaminated by chemical and biological toxins and infectious agents. In general, both conventional and improved photocatalysts have been applied with a specific requirement of UV light to stimulate photocatalysis. Photocatalysts have not, however, been employed in the field of particulate respirators. This may be due, in part, to the conventional requirement of photocatalysts with intense UV illumination. It is well known that UV light can damage exposed skin and significant exposure to UV radiation may result in skin cancer. Recently, however, Tanaka et al. disclosed a photocatalyst that is effective at low light intensities and at visible wavelengths of light (longer than UV) that are not harmful. See U.S. Pat. No. 6,828,273, which issued on Dec. 7, 2004, the entirety of which is incorporated by reference herein. Thus, the photocatalysts that may be employed in the respirator facepieces according to the present invention may be effective at wavelengths in the UV spectrum (defined as having a wavelength of from about 10 nm to about 400 nm), in the visible spectrum (defined as having a wavelength of from about 400 nm to about 750 nm), or both.

The photocatalyst particles may be incorporated into the facepiece according to the present invention by any of a variety of different particulate application processes, well known to those skilled in the art. Non-limiting examples of processes for incorporating photocatalyst particles into facepieces include spraying, dipping, coating, or a gel-sol application methods, with spraying processes being particularly desirable. The size of the photocatalyst particles may also vary widely depending, for example, on the activity of the photocatalyst as well as on the application process that is employed. In some non-limiting aspects of the present invention, the photocatalysts have an average particle size ranging from about 1 nm to about 500 nm, e.g., from about 10 nm to about 250 nm or from about 20 nm to about 150 nm. It is contemplated, however, that even larger photocatalyst particles may also be employed, for example, photocatalyst particles having an average particle size greater than 500 nm, greater than 1 μm, greater than 5 μm or even larger.

In one embodiment of the present invention, light would be distributed by optical fibers, light pipes, ribbons or sheets over and within the filter substrate to ensure effective photo-oxidation over the entire filter. This is especially important when working with highly infectious agents, such as TB and pneumonic plague, when a single microbe entering the lungs is capable of causing infection. Distribution of light by optical fibers clad in a photocatalyst has been described by Iimura in the manufacture of a catalytic reactor. See U.S. Pat. No. 6,771,866, which issued on Aug. 3, 2004, the entirety of which is incorporated by reference herein. The present embodiment differs in that the photocatalyst is bound to a porous filter substrate which traps particulates, and the optical conductors are used to distribute light over and within the filter substrate to activate the photocatalyst and destroy harmful agents and chemicals trapped on and within the filter substrate.

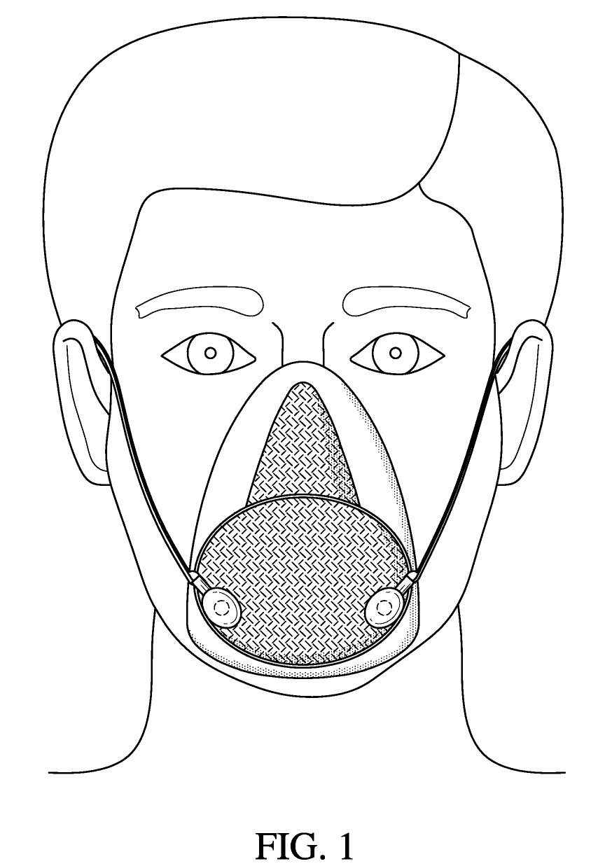

FIG. 1 illustrates a self-sterilizing disposable particulate respirator facepiece according to one non-limiting embodiment of the present invention. The facepiece illustrated in FIG. 1 employs a photocatalyst and dual battery powered light emitting diode illuminators.

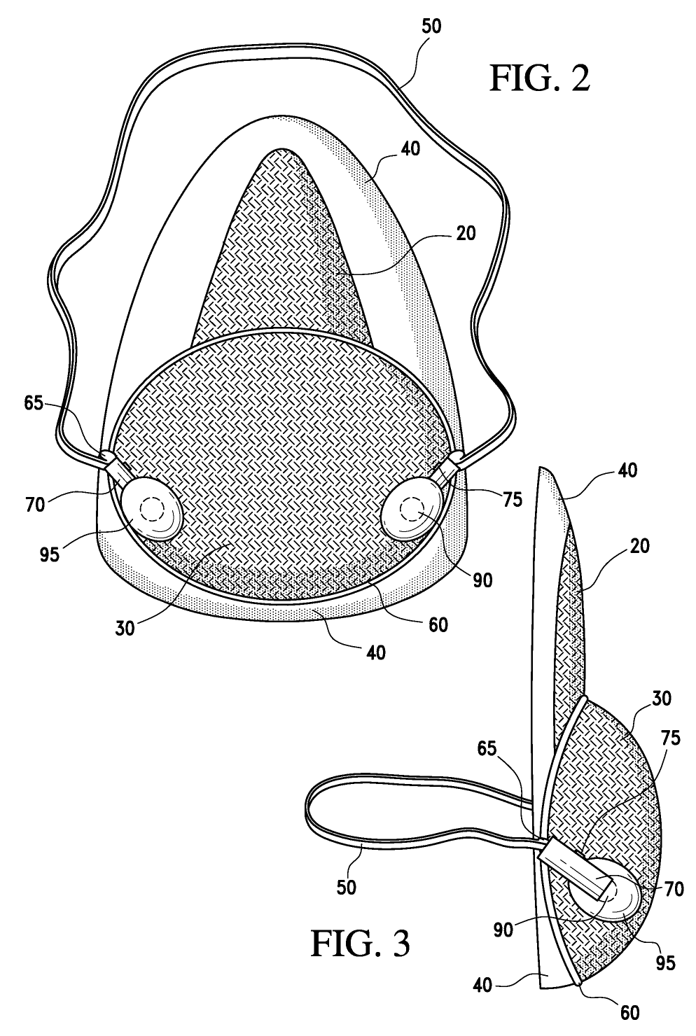

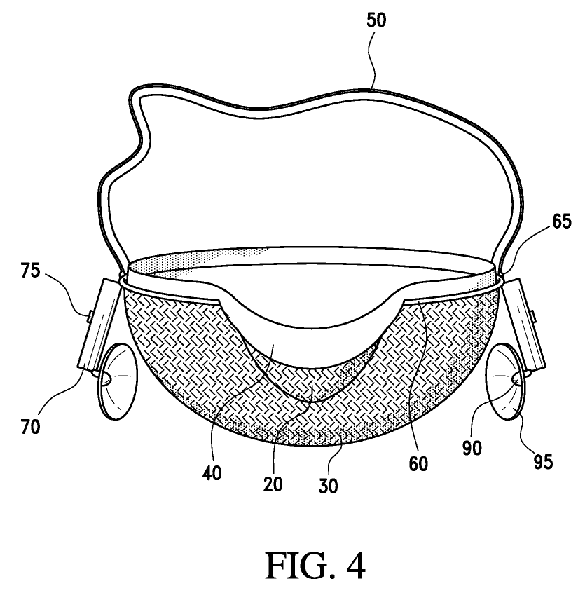

As shown in FIG. 2, a disposable particulate respirator facepiece is shown comprising a particulate air filter 30 covering the mouth and nostrils. The air filter has been treated with photocatalyst, for example, titanium dioxide nano-particles, as indicated by shading of air filter 30 in FIGS. 2, 3, and 4. A non-porous, deformable nose piece 20 extending over the bridge of the nose can be shaped to accommodate the nose comfortably. The nose piece 20 also optionally has been treated with photocatalyst. A non-porous, elastic membrane 40 surrounds the nose piece 20 and air filter 30 forming the sides of the particulate respirator facepiece. A flat elastic head band 50 is attached on each side of the particulate respirator facepiece. The elastic head band 50 is positioned around the user's head, securing the particulate respirator facepiece in place, and maintaining a seal between the elastic membrane 40 and the user's face (See FIG. 1). One, two, or more small L.E.D. lamp assemblies (comprised of components 90, 95, 70, 75) are attached to the facepiece. As shown in FIG. 2, two small L.E.D. lamp assemblies (comprised of components 90, 95, 70, 75) are on the right and left sides of an attachment ring 60 that circumscribes the air filter. The L.E.D. lamps are powered by batteries in a tubular battery holder 70, although other battery configurations are possible. Each L.E.D. lamp preferably is surrounded by a reflector 95 that helps to direct and concentrate light from the L.E.D. onto the air filter 30. An electric switch 75 on each battery holder turns the power to the L.E.D. lamps on or off. The attachment ring is reinforced 65 where the elastic band 50 and battery holder 70 are attached. In operation, light from the L.E.D. lamps 90 activates the photocatalyst, destroying pathogens and other organic particulates on the air filter 30.

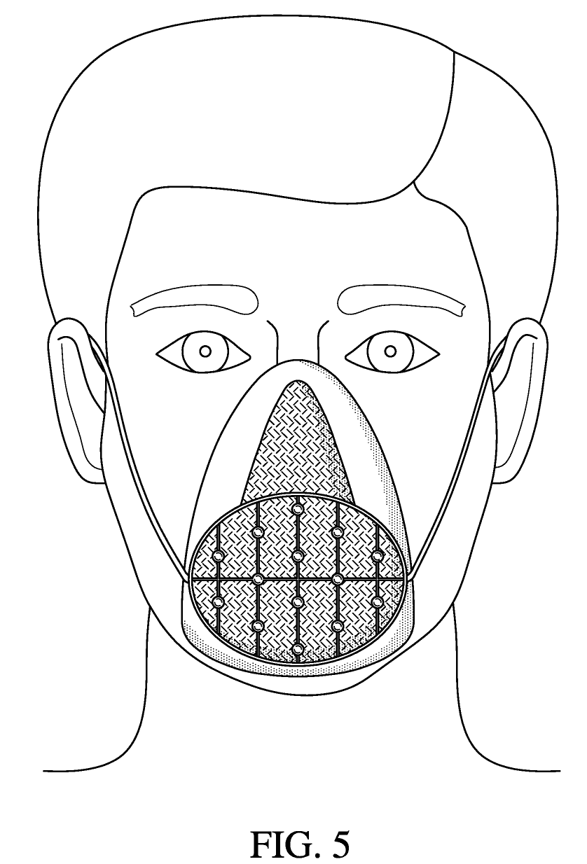

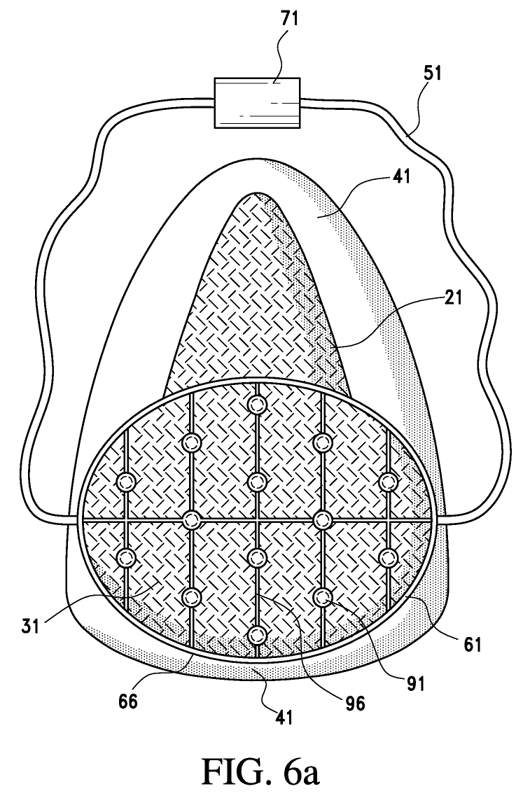

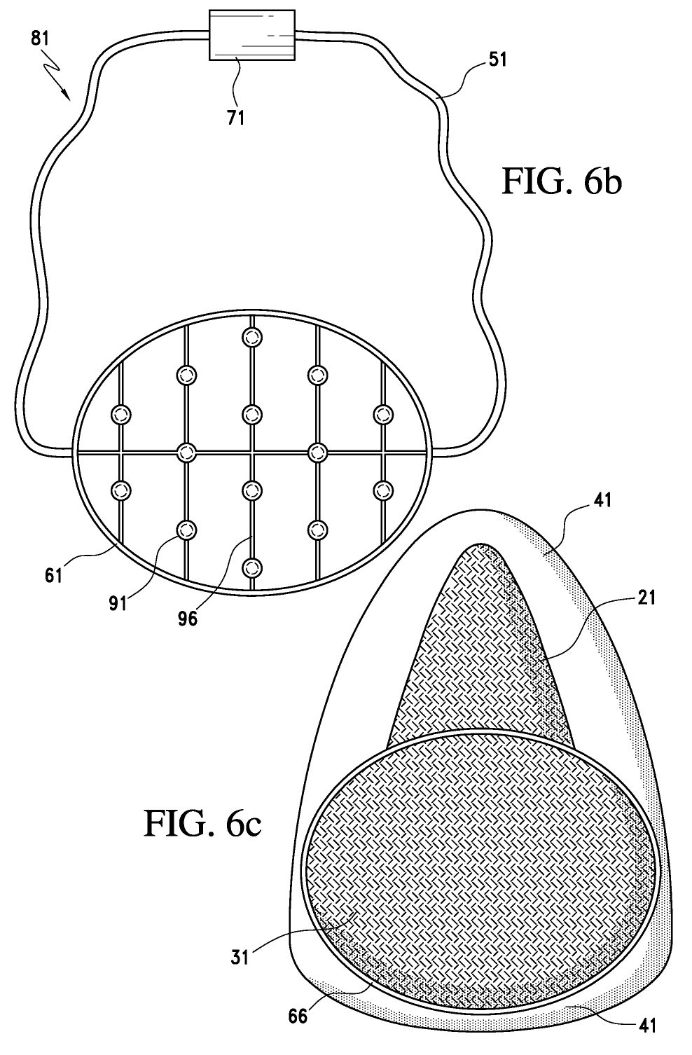

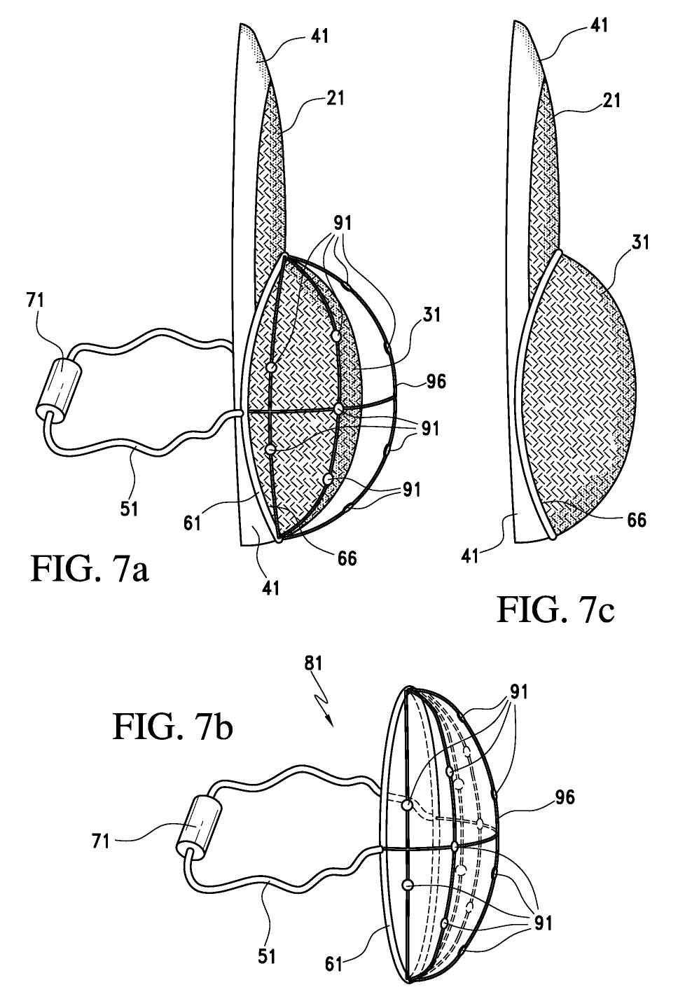

In another non-limiting embodiment, shown in FIGS. 5, 6 and 7, the invention comprises a reusable particulate respirator facepiece comprising replaceable air filter module (FIGS. 6C and 7C) covering the mouth and nostrils. The air filter portion of the replaceable air filter module has been treated with photocatalyst, for example, titanium dioxide nano-particles, as indicated by shading 31. A non-porous, deformable nose piece 21 extending over the bridge of the nose can be shaped to accommodate the nose comfortably. The nose piece 21 also optionally has been treated with photocatalyst. A non-porous, elastic membrane 41 surrounds the nose piece 21 and air filter 31 forming the sides of the particulate respirator facepiece. The replaceable air filter module is held to a re-usable headband/illuminator 81 (See FIGS. 6B & 7B) by an attachment ring 61 that sits in a groove 66 that runs around the perimeter of the air filter portion of the replaceable air filter module. A flat elastic tube forms an elastic head band 51 attached on each side of the attachment ring 61. The elastic head band 51 is positioned around the user's head, securing the assembled particulate respirator facepiece in place, and maintaining a seal between the elastic membrane 41 and the user's face. A small battery operated power supply 71 is attached to the elastic head band 51, although other configurations are possible. A pair of conductors run inside the flattened tube that forms the elastic head band 51 from the aforementioned power supply 71 to one or more, preferably a plurality of (14 are shown) light emitting diodes 91 (LEDs) mounted on a rigid superstructure 96 connected to the attachment ring. The LEDs are mounted facing down toward the air filter. Light from the LEDs shining onto the air filter portion of the replaceable air filter module activates photocatalyst (shading) killing pathogens that collect on the air filter 31. When the air filter module (FIGS. 6C and 7C) needs replacement, the old air filter module can be detached from the attachment ring 61 and disposed of with minimal handling, and replaced with a new air filter module.

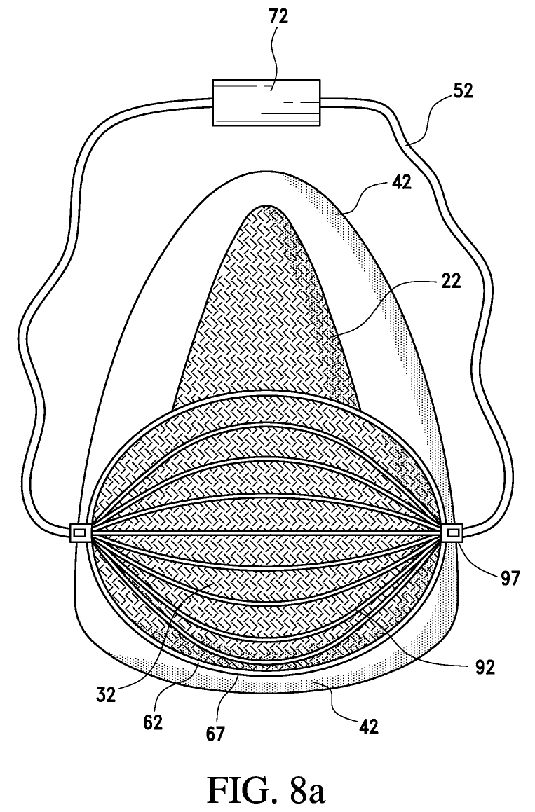

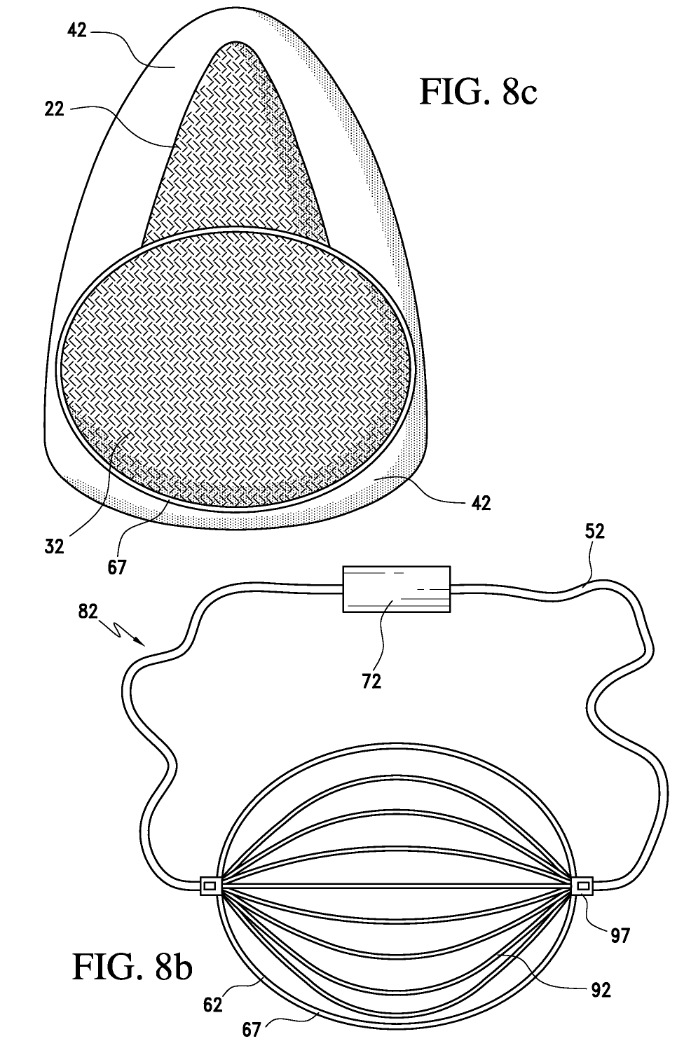

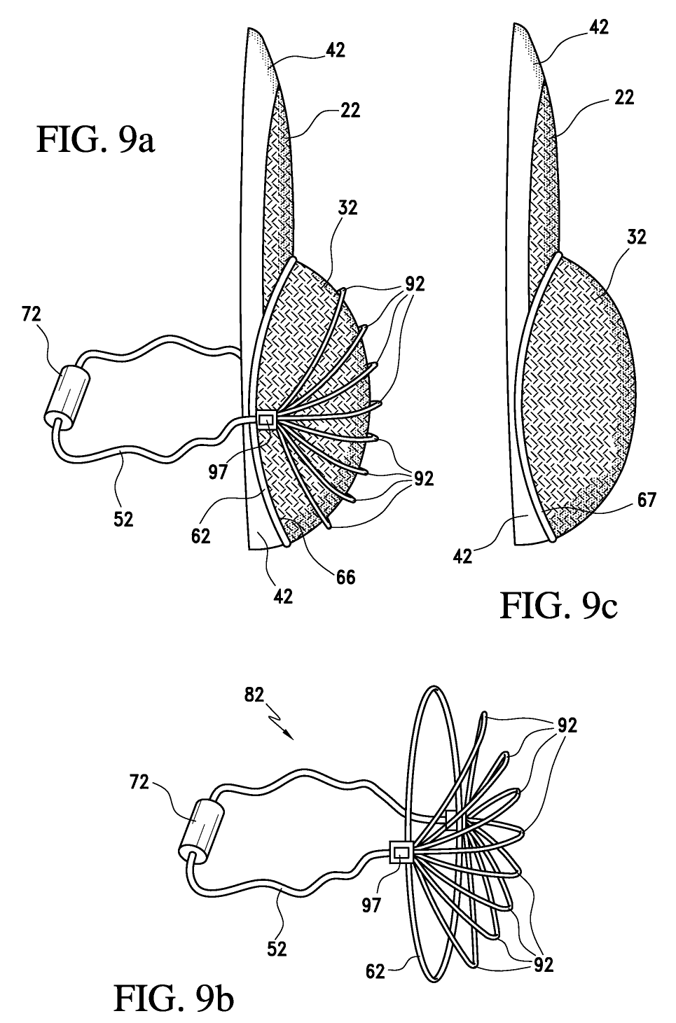

In another non-limiting embodiment, shown in FIGS. 8, and 9, the invention comprises a reusable particulate respirator facepiece comprising a replaceable air filter module (FIGS. 8C and 9C) covering the mouth and nostrils. The air filter portion of then replaceable air filter module has been treated with photocatalyst, for example, titanium dioxide nano-particles, as indicated by shading 32. A non-porous, deformable nose piece 22 extending over the bridge of the nose can be shaped to accommodate the nose comfortably. The nose piece 22 also optionally has been treated with photocatalyst. A non-porous, elastic membrane 42 surrounds the nose piece 22 and air filter 32 forming the sides of the particulate respirator facepiece. The replaceable air filter module is held to a re-usable headband/illuminator 82 (See FIGS. 8B & 9B) by an attachment ring 62 that sits in a groove 67 that runs around the perimeter of the air filter portion of the replaceable air filter module. A flat elastic tube forms an elastic head band 52 attached on each side of the attachment ring 62. Said elastic head band 52 is positioned around the user's head, securing the assembled particulate respirator facepiece in place, and maintaining a seal between the elastic membrane 42 and the user's face. A small battery operated power supply 72 is attached to the elastic head band 52, although other configurations are possible. A pair of conductors run inside the flattened tube that forms the elastic head band 52 from the aforementioned power supply 72 to 2 (LEDs) 97 mounted on the attachment ring. The LEDs illuminate the ends of 8 light conducting fibers or ribbons 92. The light conducting ribbons are oriented with the wide flat surface parallel to the surface of the air filter module. The light conducting ribbons are leaky and diffuse light uniformly over their length. A reflective coating on the outward face of the light conducting ribbon reflects light toward the air filter module. Light from the light conducting ribbons illuminates the air filter portion of the replaceable air filter module activates photocatalyst (shading) killing pathogens that collect on the air filter 32. When the air filter module (FIGS. 8C and 9C) needs replacement, the old air filter module can be detached from the attachment ring 62 and disposed of with minimal handling, and replaced with a new air filter module.

While the present invention has been described with reference to exemplary embodiments, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

I claim:

1. A particulate respirator, comprising:
a facepiece having an air flow pathway; and
a photocatalyst disposed along at least a portion of the air flow pathway.

2. The particulate respirator of claim 1, further comprising:
a light source disposed to irradiate the photocatalyst.

3. The particulate respirator of claim 2, wherein the photocatalyst is irradiated by light emitted by a light conductor.

4. The particulate respirator of claim 3, wherein the light conductor is selected from the group consisting of fibers, pipes, ribbons and sheets.

5. The particulate respirator of claim 2, wherein the photocatalyst is effective at wavelengths in the UV spectrum.

6. The particulate respirator of claim 5, wherein the photocatalyst is irradiated by light emitting diodes emitting in the UV spectrum.

7. The particulate respirator of claim 2, wherein the photocatalyst is effective at wavelengths in the visible spectrum.

8. The particulate respirator of claim 7, wherein the photocatalyst is irradiated by light emitting diodes emitting in the visible spectrum.

9. The particulate respirator of claim 5, wherein the photocatalyst is irradiated with light emitted from a light conductor selected from the group consisting of fibers, pipes, ribbons and sheets.

10. The particulate respirator of claim 6, wherein the photocatalyst is irradiated with light emitted from a light conductor selected from the group consisting of fibers, pipes, ribbons and sheets.

11. The particulate respirator of claim 7, wherein the photocatalyst is irradiated with light emitted from a light conductor selected from the group consisting of fibers, pipes, ribbons and sheets.

12. The particulate respirator of claim 8, wherein the photocatalyst is irradiated with light emitted from a light conductor selected from the group consisting of fibers, pipes, ribbons and sheets.

13. A filter having a fluid flow pathway and a photocatalyst disposed along at least a portion of the fluid flow pathway, wherein the photocatalyst is irradiated with light emitted from a light conductor selected from the group consisting of fibers, pipes, ribbons and sheets.

14. A method for effectively destroying a contaminant on a particulate respirator, comprising:
(a) providing a particulate respirator comprising a facepiece having an air flow pathway and a photocatalyst disposed along at least a portion of the air flow pathway, wherein the air flow pathway comprises the contaminant; and
(b) irradiating the photocatalyst with electromagnetic radiation under conditions effective to destroy the contaminant.

15. The method of claim 14, wherein the electromagnetic radiation comprises UV radiation.

16. The method of claim 14, wherein the destroying of the contaminants comprises photo-oxidizing the contaminant.

17. The method of claim 14, wherein the particulate respirator further comprises a light source disposed to irradiate the photocatalyst.

18. The method of claim 14, wherein the photocatalyst is irradiated by light emitted by a light conductor.

19. The method of claim 18, wherein the light conductor is selected from the group consisting of fibers, pipes, ribbons and sheets.

20. The method of claim 18, wherein the photocatalyst is effective at wavelengths in the UV spectrum.

21. The method of claim 20, wherein the photocatalyst is irradiated by light emitting diodes emitting in the UV spectrum.

22. The method of claim 18, wherein the photocatalyst is effective at wavelengths in the visible spectrum.

23. The method of claim 22, wherein the photocatalyst is irradiated by light emitting diodes emitting in the visible spectrum.

24. The method of claim 18, wherein the photocatalyst is irradiated with light emitted from a light conductor selected from the group consisting of fibers, pipes, ribbons and sheets.
